(19) United States
(12) Patent Application Publication
(10) Pub. No.: US 2005/0252708 A1
(43) Pub. Date: Nov. 17, 2005

(54) Method and device for actuating a restraining means in a vehicle

(76) Inventor: Marc Theisen, Besigheim (DE)

Correspondence Address: KENYON & KENYON, ONE BROADWAY, NEW YORK, NY, 10004, US

(21) Appl. No.: 10/508,399

(22) PCT Filed: Feb. 13, 2003
(86) PCT No.: PCT/DE03/00426

§ 371 Date: May 25, 2005

(30) Foreign Application Priority Data
Mar. 22, 2002 (DE) 102 12 996.7
May 25, 2002 (DE) 102 23 363.2

(51) Int. Cl. B60R 21/00

(52) U.S. Cl. 180/268

(57) ABSTRACT

A method and a device for triggering a restraining device in a vehicle are provided. At least one parameter that is representative of the probability of a collision of the vehicle with an obstacle is determined and the restraining device is triggered when such a collision probability is recognized. The intensity of the triggering of the restraining device is a function of the value of the at least one parameter.

### FIELD OF THE INVENTION

The present invention is directed to a method and device for triggering a restraining device in a vehicle.

### BACKGROUND INFORMATION

Currently, irreversible pyrotechnical and reversible electrical restraining devices are used. Seatbelt tighteners are representative of such reversible restraining devices. Pyrotechnical seatbelt tighteners are triggered using a method that analyzes the deceleration signals caused by the impact. In addition, methods are known that calculate the triggering of an electrical seatbelt tightener and actuate the seatbelt tightener based on vehicle dynamics data. A method for triggering an electrical seatbelt tightener that is capable of actuating the seatbelt tightener based on oncoming objects is not currently known.

Pyrotechnical seatbelt tighteners are irreversible. This means they are not activated until a crash is taking place. When a crash of this nature takes place, the occupants are subjected to relatively high decelerative forces. With conventional seatbelt tighteners, it is therefore not possible to secure the occupants in the optimum seated position before impact.

Since electrical seatbelt tighteners are reversible, they can also be actuated even before a potential impact. With the method based on vehicle dynamics data, it is possible to trigger reversible seatbelt tighteners, but this method responds only when prompted by the vehicle dynamics, e.g., when the vehicle appears to be on the verge of breaking away.

This method does not respond, however, when the vehicle is still in the normal driving state, and an object is suddenly oncoming and a crash is imminent. The method of the present invention presented herein therefore attempts to provide a response in situations in which an object approaches the vehicle in such a manner that a crash may occur with the goal of securing the occupants in an optimum seated position.

### SUMMARY OF THE INVENTION

According to the present invention, information measured by a precrash sensor system is analyzed, a reversible restraining device actuated, and a comfort functionality is activated so that the belt force is reduced if objects that appear to be on the verge of hitting the vehicle are recognized as periodically recurring objects by the sensor system. A situation of this nature occurs, for example, when a vehicle travels relatively closely along the barriers at a highway construction site. Due to the measuring inaccuracy of the sensor system, it cannot be unambiguously determined whether the barrier contacts the vehicle or not. Since there is a danger of a crash occurring, the reversible restraining device must be activated. It is, however, not only very uncomfortable for the occupants when the seatbelt tightener tightens permanently, but this also threatens to overload the seatbelt tightener, which increases wear. If the precrash sensor system therefore periodically collects the same data over a certain period of time, it can be assumed that the driver has recognized the situation, and the intensity of the restraining device, e.g., the force of the seatbelt tightener, can be reduced. If a non-periodic object should suddenly appear, however, so that increased belt force is required, the reduction of the belt force is halted immediately. A loss of safety resulting from a suddenly-changing situation is therefore prevented.

The interplay of the corresponding sensor system, e.g., the precrash sensor system in this case, and the corresponding actuator system, namely the reversible restraining device, offers the advantage that the occupant may be held in the optimum seated position when an object appears to be on the verge of impacting the vehicle. In addition, this safety system offers the advantage that the intensity of the restraining device is reduced when it may be assumed that the driver has recognized the situation. The protective effect of the system is not diminished, however.

### BRIEF DESCRIPTION OF THE DRAWINGS

FIG. 1 is a block diagram of an embodiment of the device according to the present invention.

FIG. 2a schematically illustrates an angle of impact between a vehicle's longitudinal axis and a trajectory of the object.

FIG. 2b schematically illustrates an offset distance between a point of impact with an object and the longitudinal axis of the vehicle.

FIG. 3 schematically illustrates how force increases with velocity in the range when the offset is fixed.

FIG. 4 shows a diagram of an example method that takes place in processor 4 shown in FIG. 1.

FIG. 5 illustrates an example mode of operation of block 407 shown in FIG. 4 in greater detail.

FIG. 6 illustrates four adjacent points for the point defined by offset and angle calculated in a grid.

FIG. 7 shows a detailed design of module 408 in FIG. 4 for reducing belt force.

### DETAILED DESCRIPTION

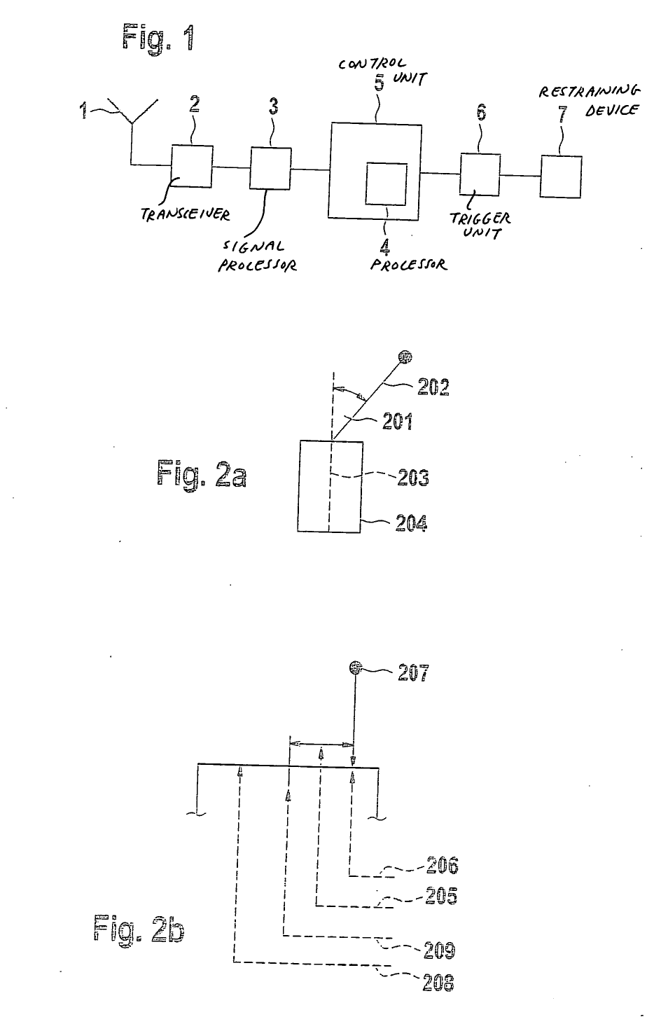

An embodiment of device according to the invention is depicted in FIG. 1 as a block diagram. An antenna 1 of a precrash sensor is connected to a transceiver station 2 that also generates signals, i.e., it includes an oscillator for generating radar signals. In this case, it is therefore a microwave transceiver station, so that antenna 1, which acts as transceiver antenna, forms a radar sensor together with transceiver station 2. For purposes of simplicity, only one radar sensor is shown here. A motor vehicle may have more than one radar sensor, however. As an alternative to the radar sensor, it is also possible to use a video sensor, an ultrasound sensor, an infrared sensor, a laser, etc., and/or combinations of these. A signal processing unit 3 is installed downstream from transceiver station 2; it analyzes the signals received from transceiver station 2 and thereby determines the speed of impact, the time of impact, and the offset and angle of impact of the detected object. This data is then transferred by signal processing unit 3 to the first data input of a processor 4. This line may be a two-wire line, an optical line, or a bus. Signal processing unit 3 and/or its functions may be allocated to transceiver station 2, processor 4, or a further processor (not shown in FIG. 1) that is independent of these. In this case, antenna 1, transceiver station 2 and signal processing unit 3 form the precrash sensor system.

Processor 4 is either a separate control unit or it is integrated in a control unit 5, e.g., in the airbag control unit. A restraining device triggering unit 6 that actuates restraining device 7 is connected to control unit 5. Reversible restraining devices, such as reversible electrical seatbelt tighteners, for example, are provided in a motor vehicle as restraining device 7. Only one restraining device is shown here, as an example. Restraining device triggering unit 6 may trigger more than one restraining device. The connection between airbag control unit 5 and restraining device triggering unit 6 may take place via a bus, a two-wire line, an optical fiber, a magnetic coupling, or wireless transmission.

The method described herein below takes place in processor 4. Accordingly, processor 4 may function as a control unit.

An objective is to calculate the belt force based on the offset, the angle of impact, the absolute value of the speed of impact, and the time of impact. The calculation takes into account the fact that, if events are repetitive in nature, the belt force may be reduced, e.g., by half. The method may be used analogously when the velocity component in the direction of the vehicle's longitudinal and transverse axis is utilized instead of the angle of impact and the absolute value of the impact speed vector. It will be assumed herein below that the angle of impact and the absolute value of the speed of impact are provided (reference is made to German Published Patent Application No. 198 54 380 as an example).

If a speed of impact and a time of impact are not measured, then an object that could result in a crash is not present. This case is distinguished from the case in which these parameters have the value 0, because this means that an object ahead of the vehicle is moving at the same speed.

If the speed of impact is below a certain very low threshold, the seatbelt tightener is not actuated.

If the relative velocity exceeds the threshold, the belt force is influenced by the relative velocity only in that the minimum distance—as measured from the center of the vehicle outward—that must be maintained from a passing object is a function of the relative velocity. In other words, the more slowly one drives past an object at the same distance from the center of the vehicle, the less critical is the prospect of the object hitting the vehicle. The reverse is true: the higher the relative velocity, the greater the minimum distance away from the vehicle center an object must be to ensure that the vehicle is able to drive past safely.

Angle of impact 201 is understood herein to be the angle between vehicle's longitudinal axis 203 and trajectory 202 of the object (refer to FIG. 2a). The smaller the angle of impact, therefore, the greater is the deceleration that vehicle 204 undergoes when it hits the object, and the more intensively the belt is tightened.

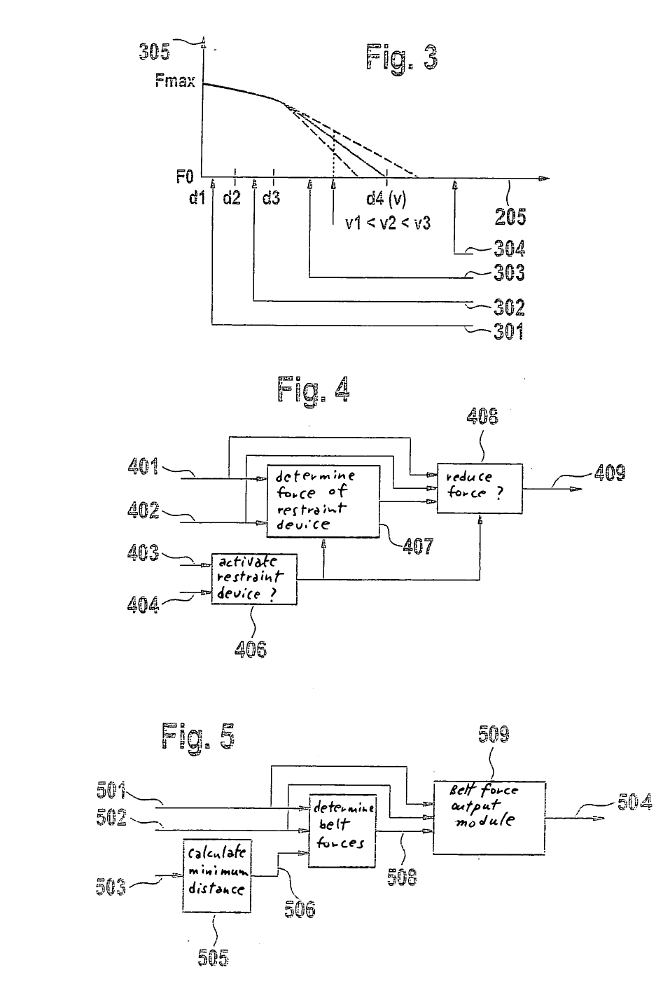

Offset 205 is the distance between point of impact 206 with object 207 and longitudinal axis 209 of the vehicle (refer to FIG. 2b). To illustrate the relationship between belt force 305 and offset 205, a distinction is made between a plurality of different cases. They include the variant in which belt force 305 is the same in every case, i.e., none of the cases is different. For purposes of simplicity, only the right half of the vehicle will be considered (refer to FIG. 3). When making a distinction between cases, they can be the following four cases 301-304, for example:
1. Case 301: Offset d1 is greater than or equal to 0, and less than or equal to half of the vehicle width. Since the vehicle is particularly stiff in this zone, the belt force (Fmax) is greatest in this case.
2. Case 302: Offset d2 is greater than half the width of the frame, and less than or equal to half of the vehicle width. The object is therefore certain to hit the vehicle. The smaller the offset is, the harder is the impact, the greater is the decelerative force, requiring a proportionately greater the belt force.
3. Case 303: Offset d3 is greater than half the width of the vehicle and less than or equal to the distance that is maintained for the sensor system to be capable of detecting safe passage, with consideration for measuring tolerances. The smaller the measured offset is, the greater is the probability that the object will hit the vehicle, requiring a proportionately greater belt force.
4. Case 304: Offset d4 is greater than the distance that is required to detect a safe drive-by, and it is less than or equal to the maximum distance that is taken into consideration. The object is therefore certain not to hit the vehicle. The seatbelt tightener therefore need not be actuated.

The belt force characteristic curve is therefore a function of angle of impact 305 and offset 205. Given a fixed angle, the force is a defined function of the offset, as sectionally explained above. In the cases in which the object is certain to hit or not hit, the force is independent of velocity. The force is a function of velocity only in the range in which it cannot be determined with certainty whether the object will be hit or not. The range increases with velocity. As shown in FIG. 3, force increases with velocity in this range, when the offset is fixed. This is because the potential for danger increases as velocity increases. This method also allows for the fact that this range stops increasing at a certain velocity, since one can assume that the driver is safely driving by, so the belt force is no longer increased as velocity increases, thereby increasing comfort.

FIG. 4 shows the diagram of the method that takes place in processor 4 in FIG. 1. Input variables are offset 401, angle of impact 402, speed of impact 403, and time of impact 404. If the input variables are not the offset and angle of impact, but rather the velocity in the longitudinal and transverse direction of the vehicle, then an additional unit is used to convert the input variables. It is assumed herein below that angle and offset are given. The output variable of the entire method is belt force 405. There are many possible variants for indicating belt force. According to two possible variants, for example, the output signal defines the force directly, or the signal indicates the absolute value of the increase or reduction in force. Both variants can be converted to the other using an additional module. It is assumed herein below that the output signal is a direct indication of force. At the highest level of abstraction, as shown in FIG. 4, the method is then composed of the three blocks 406, 407 and 408. Module 406 compares the speed of impact with a threshold and calculates, based on the speed of impact, whether the seatbelt tightener needs to be activated at all. Based on the offset and angle, and with the aid of the force characteristic, module 407 determines the force of the seatbelt tightener. A calculation is performed in module 408, based on the offset and angle data that are obtained currently and that were obtained in the preceding period of time, to determine if the belt force calculated in module 407 may be reduced or not. The length of the preceding period of time is parametrizable.

In FIG. 5, the mode of operation of block 407 is illustrated in greater detail. The input parameters are offset 501, angle 502 and velocity 503. Output 504 is the force, with no consideration for possible reduction. In module 505, minimum distance 506 to be maintained is calculated as a function of velocity, so that a crash can be ruled out with certainty. As shown in FIG. 6, the four adjacent points for the point defined by offset and angle are calculated in a grid. The particular belt forces for these four adjacent points are read out of a belt force table to be parametrized, and they are provided to module 509 via 508.

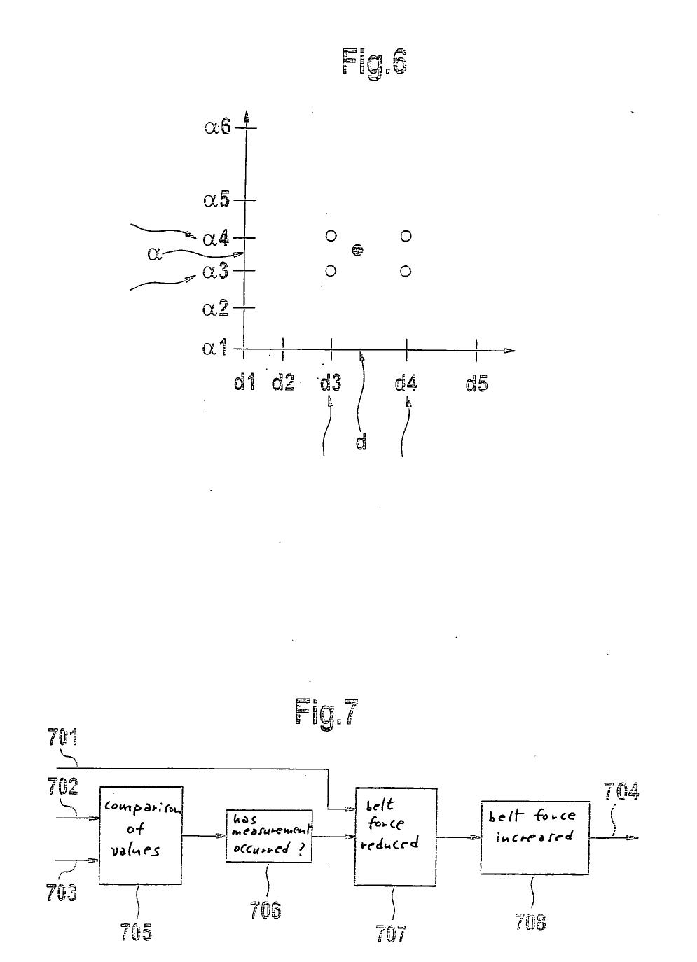

The detailed design of module 408 in FIG. 4 for reducing belt force is shown in FIG. 7. Inputs are unreduced force 701, offset 702 and angle 703. The output is belt force 704, which may or may not be reduced. The instantaneous values for offset and angle are initially compared in module 705 with the values from the preceding period of time. The preceding values may be stored in a ring memory, for example. After the comparison, the updated values are added to the list of preceding values, and they replace the oldest values. The individual comparisons result in a signal sequence that indicates whether the updated values match a value pair obtained in the past. In block 706, a check is run to determine whether the present measurement occurred repeatedly in the past and at regular intervals. If this is the case, the belt force is reduced in module 707. This may take place in one or more steps, and the extent of the reduction may be applied. If an object has appeared that poses a higher potential for danger, the reduction is halted immediately, and the belt force is increased in accordance with the potential for danger. This takes place in module 708.

1-5. (canceled)

6. A method for triggering a restraining device in a vehicle, comprising:
determining a value of at least one parameter relating to an impact with an object based on data provided from a pre-crash sensor system; and
adjusting an intensity of the triggering of the restraining device as a function of the value of the at least one parameter.

7. The method of claim 6, wherein the at least one parameter includes at least one of an offset of an expected point of impact from a longitudinal axis of the vehicle, an expected angle of impact with an object, an expected speed of impact, and an expected time of impact.

8. The method as recited in claim 7, wherein the intensity of the triggering is reduced when an object is periodically detected by the pre-crash sensor system over a predetermined period of time.

9. A device for triggering a restraining device in a vehicle having a pre-crash sensor system, the device comprising:
a control unit configured to determine at least one parameter based on data from the precrash sensor system, the control unit configured to transmit at least one output signal for triggering the restraining device as a function of the at least one parameter; and
an arrangement for adjusting an intensity of the triggering of the restraining device coupled to the control unit, the arrangement adjusting the intensity as function of the at least one output signal.

10. The device of claim 9, wherein the restraining device is a reversible restraining device.
